(19) United States
(12) Patent Application Publication
(10) Pub. No.: US 2025/0188988 A1
(43) Pub. Date: Jun. 12, 2025

(54) LINEAR BEARING FOR A LINEAR ACTUATOR

(71) Applicant: Festo SE & Co. KG, Esslingen (DE)

(72) Inventors: Benjamin WEHLE, Stuttgart (DE); Christian SCHWEIZER, Filderstadt (DE)

(21) Appl. No.: 18/967,049

(22) Filed: Dec. 3, 2024

(30) Foreign Application Priority Data
Dec. 8, 2023 (DE) 10 2023 134 422.6

(51) Int. Cl. F16C 29/02

(52) U.S. Cl. CPC F16C 29/02; F16C 2380/00

(57) ABSTRACT

Linear bearing for a linear actuator, with an outer tube extending along a movement axis and an end assembly that includes a closing sleeve, a connecting piece, a fastening adapter, a first ring seal and a second ring seal, the connecting piece having a coupling section for fixed coupling to the outer tube, a carrier section for bearing against an inner surface of the outer tube and/or an inner surface of the fastening adapter, and a connecting section for receiving the end sleeve, the ring seals being arranged in annular gaps between the end sleeve and the fastening adapter or between the fastening adapter and the outer tube, and an actuator rod being mounted in the outer tube so as to be linearly movable.

### CROSS-REFERENCE

This application claims the benefit of German application DE 102023134422.6, filed Dec. 8, 2023, which is incorporated herein by reference.

The invention relates to a linear bearing for a linear actuator.

A linear actuator can be designed, for example, as a pneumatic cylinder or as an electric motor with a flanged threaded spindle arrangement or as an electric linear direct drive and is used to provide a linear actuating movement. This actuating movement is usually transmitted by an actuator rod that is accommodated in a bearing housing in a linearly movable manner and that is coupled to a drive component. Depending on the design of the linear actuator, this drive component is, for example, a working piston of a pneumatic cylinder or a threaded nut or a threaded spindle of a threaded spindle drive or a rotor of an electric linear motor drive.

A linear actuator of this kind comprises an assembly referred to as a linear bearing, which is used to ensure a linearly movable guide for the actuator rod and which is also designed to fix the linear actuator to a machine frame, for example.

### SUMMARY OF THE INVENTION

The purpose of the invention is to provide a linear bearing that can be used to achieve a compact design for the linear actuator.

This task is solved for a linear bearing of the type mentioned above by the linear bearing having an outer tube extending along an axis of movement and an end assembly, the end assembly being arranged on an end region of the outer tube and comprising an end sleeve, a coupling piece, a fastening adapter, a first ring seal and a second ring seal, the coupling piece having a coupling section that is designed for fixed coupling of the coupling piece to the outer tube or to an inner tube arranged in the outer tube and adjoined by a carrier section that is designed for contact with an inner surface of the outer tube and/or an inner surface of the fastening adapter, wherein a connecting section is arranged adjacent to the carrier section is, which connecting section is designed to receive the end sleeve, the first ring seal being accommodated in a first annular gap between the end sleeve and the fastening adapter and the second ring seal being accommodated in a second annular gap between the fastening adapter and the outer tube, and an actuator rod being mounted in the outer tube so as to be linearly movable along the axis of movement, which actuator rod forms the end assembly.

The outer tube forms, on the one hand, a sheath for the drive component in order to protect it from environmental influences and also serves as a mechanical connecting element via which a power transmission between the drive component and the components of the end assembly, in particular the fastening adapter, is made possible. The outer tube extends, preferably with a constant profile, along an axis of movement, along which a relative movement of the actuator rod with respect to the outer tube is provided. For example, the outer tube is designed as a circular cylindrical tube, in which case the axis of movement is formed by the center axis of the outer tube.

The outer tube has an end section at each of its opposite ends, with an end assembly being arranged on at least one of the end sections, with which end assembly different functions for the linear bearing are realized. One function of the end assembly, in particular of the end sleeve, is to close the front end of the outer tube and to provide a through-hole for the actuator rod so that the actuator rod can perform the desired relative movement with respect to the outer tube. Another function of the end assembly, which is essentially performed by the fastening adapter, is to provide at least one mounting surface that can be used to mechanically couple the fastening adapter to another component, such as a machine frame.

To ensure that the fastening adapter is coupled favorably to the outer tube, the end assembly includes a coupling piece that is designed to be fixedly attached to the outer tube. For this purpose, the coupling piece comprises a coupling section which is either directly or via another component, such as an inner tube arranged in the outer tube, connected to the outer tube in a force-locking and/or form-locking manner and/or allows a force introduction from the end assembly to the outer tube and a force derivation from the outer tube to the end assembly. Depending on the design of the linear bearing, it may be provided that an inner tube is arranged in the outer tube, in which case it may be provided that the connecting piece is fixed to the inner tube by means of the coupling section and that there is only an indirect connection to the outer tube.

A carrier section adjoins the coupling section along the axis of movement, which is designed to rest against an inner surface of the outer tube and/or to rest against an inner surface of the fastening adapter. It is preferably provided that an outer surface of the carrier section rests both against the inner surface of the outer tube and against the inner surface of the fastening adapter and thus provides an advantageous support for the fastening adapter. The carrier section is adjoined along the axis of movement by a connecting section that is designed to receive and, in particular, to fix the end sleeve. It is advantageous if the coupling section, the carrier section and the connecting section are each designed with a constant profile and are arranged in a row along the axis of movement. It is particularly advantageous if the connecting piece encompasses the coupling section, the carrier section and the connecting section in a single piece.

In order to adapt the linear bearing to different operating conditions, the fastening adapter is designed as a separate component that can be easily replaced. This results in a first annular gap between the fastening adapter and the end sleeve and a second annular gap between the fastening adapter and the outer tube. Even if the end sleeve, the fastening adapter and the outer tube are manufactured with a high degree of precision and therefore at great expense, it is not possible to configure either the first or the second annular gap in such a way that would prevent the ingress of dirt and liquids into the respective first or second annular gap during practical use of the linear bearing. This applies in particular if the linear actuator with the associated linear bearing is used in the field of food technology or pharmaceutics, where frequent cleaning processes are carried out, in particular using high-pressure water cleaners, whereby water at up to 100 bar and temperatures of almost 100 degrees Celsius is applied to the linear bearing. In order to ensure a favorable sealing effect for the first and second ring gap, a first ring seal is arranged in the first ring gap and a second ring seal is arranged in the second ring gap. The ring seals are configured in such a way that they can compensate for geometric deviations between the end sleeve and the fastening adapter or between the fastening adapter and the outer tube and thus ensure an adequate sealing effect despite relatively low quality requirements for those surfaces that delimit the respective annular gaps.

Furthermore, it is envisaged that the components of the end assembly associated with a first end region of the outer tube will be penetrated by the actuator rod that is mounted in the outer tube so as to be linearly movable. If a further end assembly is associated with a second end region of the outer tube, this is not usually penetrated by the actuator rod and is therefore configured differently, at least with regard to the end sleeve.

The actuator rod is designed for coupling with a drive component that can be accommodated in the outer tube and that is intended to transfer motion forces to the actuator rod. If the linear actuator is designed as a pneumatic cylinder, the drive component is formed by a pneumatic piston, also referred to as a working piston, which can be accommodated in a linearly movable and sealed manner in the outer tube, for example, and which forms at least one size-variable working chamber, preferably two size-variable working chambers, with the outer tube. The desired movement force can be applied by pressurizing at least one of the working chambers. If the linear actuator is designed as a threaded spindle drive, the drive component can optionally be designed as a threaded spindle or threaded nut. If the drive component is designed as a threaded spindle, it is preferably coupled in a rotationally movable manner to the actuator rod, the threaded spindle being set in rotation by a motor, in particular an electric motor, and being supported on a threaded nut fixed in a stationary manner in the outer tube. In a design of the drive component as a threaded nut, it is provided that this threaded nut is accommodated in the outer tube in a linearly movable and rotationally fixed manner and is penetrated by a threaded spindle that is rotatably movable and otherwise fixedly mounted in the outer tube and is driven by a motor, in particular an electric motor.

The invention is advantageously further developed in the subject-matter of the sub-claims.

It is advantageous if the first annular gap is bounded by an axial end face of the connecting piece and by a first axial end face of the fastening adapter and/or that the second annular gap is bounded by a second axial end face of the fastening adapter and by an axial end face of the outer tube. The first annular seal and the second annular seal each being made of a plastic material, in particular an elastomeric material. Preferably, the axial end face of the connecting piece and the first axial end face of the fastening adapter are each designed as flat surfaces, in particular as annular surfaces, and are arranged opposite one another. These flat surfaces are particularly preferably arranged in planes that are parallel to one another and oriented transversely to the axis of movement. This applies equally to the second axial end face of the connecting piece and the axial end face of the outer tube. The first and second ring seals are preferably designed with a rectangular or square profiling and are compressed in the axial direction along the axis of movement when the end assembly is mounted, in particular by screwing the end sleeve onto the connecting piece, in order to ensure the desired sealing contact on the respective axial end faces. The first and second ring seals are preferably made of a plastic material that does not lose its sealing effect and ensures reliable sealing of the respective annular gap even when hit by a jet of water that emerges from a nozzle of a high-pressure cleaner at a pressure of 100 bar and has a temperature of almost 100 degrees Celsius.

It is advantageous if a guide sleeve is arranged on an inner surface of the connecting piece, which is designed for a sliding guide of the actuator rod. Preferably, the guide sleeve is made of a metallic material, for example brass or bronze, or of a plastic material, in particular from the group of polyoxymethylenes (POM) or polyether ether ketones (PEEK), and ensures a low-backlash and low-friction guidance of the actuator rod.

In a further development of the invention, it is envisaged that the connecting section of the connecting piece is provided with an external thread and that the end sleeve has a tubular fastening section that engages with an internal thread in the external thread of the connecting piece and that rests with an external surface on the internal surface of the fastening adapter.

In a further embodiment of the invention, it is provided that a circumferential radial groove is formed on an inner surface of the connecting piece, in which groove a shaft seal ring is received, which is designed for a sealing abutment against the first connecting piece and against an outer surface of the actuator rod. With this shaft seal ring, which is penetrated by the actuator rod, a spatial separation between an interior space bounded by the outer tube and an environment of the linear bearing is ensured. The shaft seal ring is preferably made of an elastomeric material, at least in some areas, and has at least one circumferential sealing lip, preferably two sealing lips arranged at a distance from each other along the axis of movement, which sealingly engage the actuator rod. Furthermore, the shaft seal ring is held in a fixed and sealing manner in the circumferential radial groove of the connecting piece.

It is preferably provided that the fastening adapter is formed from the group: mounting ring with axially aligned threaded holes, mounting ring with pivot pins arranged on both sides and aligned radially, mounting ring with feet. One design of the fastening adapter as a mounting ring with axially aligned threaded holes is particularly useful if the linear bearing is to be fixed with a vertical alignment of the axis of motion with respect to a mounting surface of a machine frame. In this case, an external diameter of the fastening ring is selected, which external diameter is larger than the external diameter of the outer tube, whereby a circular end face of the fastening ring can be placed against the fastening surface. For the attachment of such a fastening ring, it may be necessary to provide that the fastening surface is interspersed with holes that are aligned parallel to the axis of movement and in which fastening screws can be accommodated that engage with the axially aligned threaded holes in the circular ring-shaped end face of the fastening ring. Alternatively, the fastening ring is provided with radially aligned pivot pins arranged on both sides, which can engage in corresponding bearing bushes on a machine frame, in order to be able to guarantee a pivotally movable mounting of the linear bearing with a pivot axis aligned transversely to the axis of movement. In a further alternative embodiment, the fastening ring is provided with one or more feet, wherein the respective foot has a bearing surface that is designed to be placed on a fastening surface of a machine frame and whose surface normal is aligned transversely to the movement axis. This allows the linear bearing to be fixed to a machine frame with a parallel alignment of the movement axis with respect to the fastening surface.

It is useful if a radial groove is formed around the circumference of an inner surface of the end sleeve, in which a shaft seal ring is accommodated, which is designed to fit sealingly against the end sleeve and against an outer surface of the actuator rod. With this shaft seal ring, which is penetrated by the actuator rod, a space that extends between the connecting piece and the end sleeve is sealed with respect to the environment of the linear bearing, wherein this space is located in front of the interior, which is bounded by the outer tube. This achieves a double seal between the interior and the environment. The shaft seal ring is preferably made of an elastomeric material, at least in some areas, and has at least one circumferential sealing lip, preferably two sealing lips arranged at a distance from each other along the axis of movement, which sealingly engage the actuator rod. Furthermore, the shaft seal ring is held in a stationary and sealing manner in the circumferential radial groove of the end sleeve.

In an advantageous embodiment of the invention, it is provided that the one outer surface of the outer tube and an outer surface of the fastening adapter and an outer surface of the first ring seal and an outer surface of the second ring seal and an outer surface of the end sleeve each have an identical profiling in a projection plane oriented transversely to the axis of movement. This ensures a smooth outer surface for the linear bearing in the area of the end assembly, so that there are no undesirable undercuts or other recesses that would make it difficult to clean this outer surface.

In a further development of the invention, it is envisaged that the outer tube is provided with an end assembly at each of the opposite end regions. It is preferably envisaged that the two end assemblies each have the same components (end sleeve, connecting piece, fastening adapter, ring seals), whereby these components may have identical or different geometrical designs depending on the design of the linear actuator for which the linear bearing is configured. This applies in particular to the end sleeves of the two end assemblies, which differ considerably from one another, since only one of the two end sleeves is penetrated by the actuator rod, while this is not the case with the other end sleeve.

It is preferably provided that, in one of the two end assemblies, the end sleeve has a mounting flange or is designed to couple a mounting flange, the mounting flange being designed to secure a drive motor. This is the end sleeve that is not penetrated by the actuator rod, wherein the mounting flange can optionally be designed in one piece with the end sleeve or can be coupled to the end sleeve, in particular screwed on.

### BRIEF DESCRIPTION OF DRAWINGS

An advantageous embodiment of the invention is shown in the drawings. Here shows:

FIG. 1 a perspective view of a linear actuator implemented as a threaded spindle drive with an electric motor and a linear bearing,

FIG. 2 a purely schematic sectional view of a front end region of the linear bearing according to FIG. 1,

FIG. 3 a purely schematic sectional view of a rear end region of the linear bearing according to FIG. 1,

FIG. 4: a perspective and schematic representation of a fastening adapter of annular design,

FIG. 5: a perspective and schematic representation of a fastening ring with feet, and

FIG. 6: a perspective and schematic representation of a fastening adapter of annular design with laterally protruding pivot bearing pins.

### DETAILED DESCRIPTION OF INVENTION

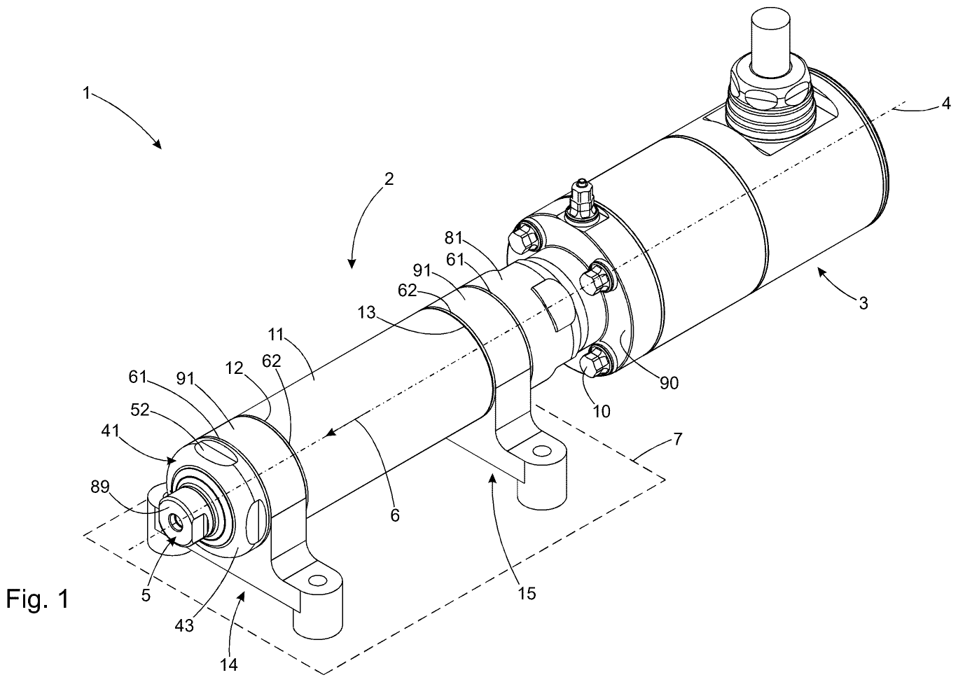

A linear actuator 1, shown only schematically in FIG. 1, comprises a linear bearing 2 and an electric motor 3. It is envisaged, purely by way of example, that the electric motor 3 drives a threaded spindle (not shown) which is mounted in the linear bearing 2 such that the threaded spindle can rotate about a movement axis 4. The threaded spindle works together with a threaded nut (not shown), that is held in the linear bearing 2 in a linearly movable and rotationally fixed manner and that is coupled to an actuator rod 5 that passes through the front end of the linear bearing 2. The actuator rod 5 is designed to be purely exemplary in the form of a circular cylinder and extends along the axis of movement 4. As shown in FIG. 1, the actuator rod 5 is in a first functional position, also referred to as the retracted position, and can be moved from this first functional position along the movement axis 4 in the direction of the symbolically drawn movement arrow 6 to a second functional position (not shown), also referred to as the extended position.

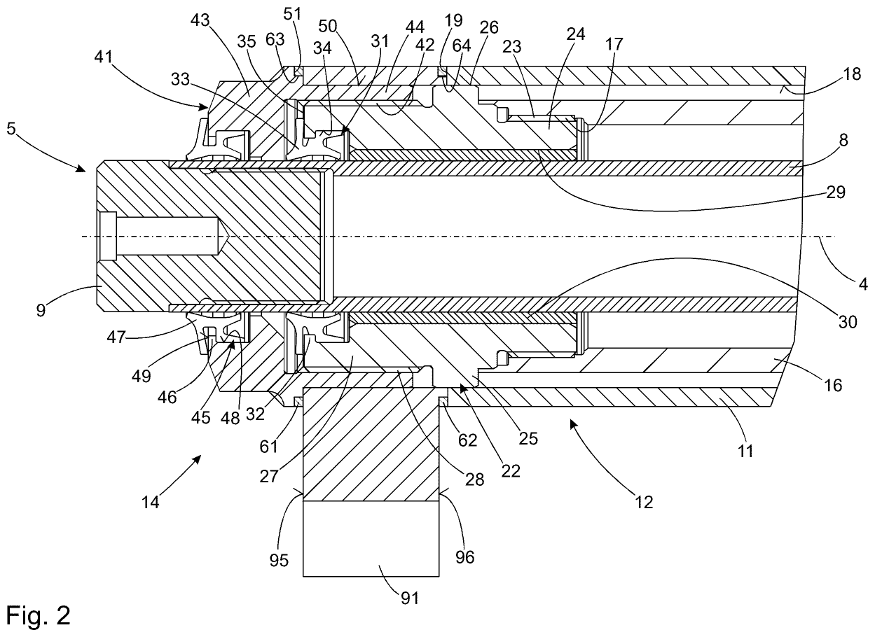

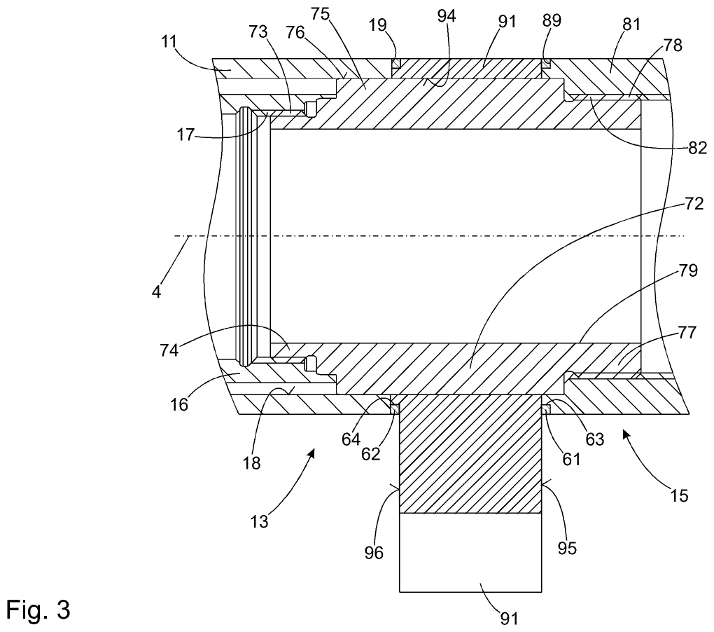

The linear bearing 2 comprises an outer tube 11, which is designed purely exemplarily as a circular cylindrical sleeve and which is provided at a first end region 12 with a first end assembly 14 and at a second end region 13 with a second end assembly 15. The first end assembly 14 is shown in more detail in FIG. 2, and the second end assembly 15 is shown in more detail in FIG. 3.

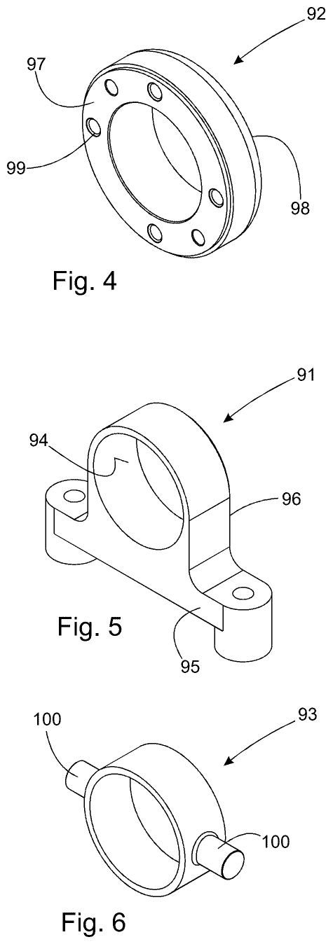

By way of example, the two end assemblies 14, 15 are each equipped with a fastening adapter 91, which is shown in more detail in FIG. 5. Each of the fastening adapters 91 can be individually replaced by another fastening adapter 92, 93 shown in FIGS. 4 and 6, in order to enable favorable mounting of the linear bearing 2 to a machine frame (not shown).

The fastening adapters 91 shown in FIG. 1, for example, can be used to fix the linear actuator 1 to a flat surface of an unspecified machine frame or chassis, with this surface being symbolized by the plane 7 shown in dashed lines.

For example, the linear actuator 1 can be used to move a machine component (not shown) along the axis of motion 4 relative to the machine frame (not shown). For this purpose, an extension movement and a retraction movement can be provided by means of the actuator rod 5, which is connected to the electric motor via the threaded nut (not shown) and the associated threaded spindle, in which a rotational movement of a drive shaft of the electric motor is converted into the desired linear movement of the actuator rod.

In another embodiment of a linear actuator, the actuator rod can be connected to a pneumatic piston of a pneumatic linear drive, which together with the outer tube delimits at least one size-variable working chamber and can perform a movement along the movement axis 4 by applying an overpressure to this working chamber. In a further embodiment of a linear actuator (not shown), the actuator rod can be connected to a slider of an electrodynamic linear direct drive, which can be subjected to magnetic forces along the axis of motion by an electric coil arrangement associated with the outer tube, in order to thereby effect the desired movement of the actuator rod.

As can be seen from the representation of FIG. 2, which shows the first end assembly 14 in detail, the first end assembly 14 comprises a first end sleeve 41, a first connecting piece 22, a first ring seal 61 and a second ring seal 62. By way of example, in the case of the linear actuator 1 designed as a threaded spindle drive, an inner tube 16 is arranged coaxially with the outer tube 11 and is provided, at an end region facing the first connecting piece 22, with an internal thread 17 which engages in an external thread 23 of the first connecting piece 22, which first connecting piece 22 is formed on a coupling section 24 of the first connecting piece 22. This threaded connection allows the inner tube 16 to support the connecting piece 22 and to take over a major part of the forces acting on the connecting piece 22. A carrier section 25 adjoins the coupling section 24 along the axis of movement 4, which carrier section 25 is designed purely exemplarily for a contact with an inner surface 18 of the outer tube 11 and with an inner surface 94 of the fastening adapter 91. As a purely exemplary embodiment, the carrier section 25 is provided with a circular cylindrical outer surface 26 in order to ensure that it is in contact with the inner surfaces 18 and 94 over as large an area as possible and thus to provide advantageous support for the outer tube 11 and the fastening adapter 91.

A connecting section 27 is arranged adjacent to the carrier section 25, which connecting section 27 is provided with an external thread 28 that is intended for engagement with an internal thread 29 formed on the first end sleeve 41. This ensures that the first end sleeve 41 is reliably fixed in place from the connecting piece 22.

Thus, the connecting piece 22 ensures a coupling between the inner tube 16, the outer tube 11, the fastening adapter 91 and the first end sleeve 41 in both the axial direction and the radial direction.

For guiding the actuator rod 5, the connecting piece 22 is provided with a through-hole 29, which is arranged coaxially with the outer surface 26 and in which a guide sleeve 30 is received. The guide sleeve 30 forms a sliding bearing for the actuator rod 5, which actuator rod 5 is formed purely exemplarily from a circular cylindrical tube 8 and an end piece 9 screwed into the tube 8 at the end. Furthermore, a radial groove 31 extending outwards in the radial direction is provided in the connecting section 27, adjacent to the through-hole 29 for the guide sleeve 30, which is limited in the axial direction by a radially inwardly projecting annular collar 32. The radial groove 31 is designed to receive a shaft seal ring 33, which, in the radial direction, sealingly engages the groove base 34 of the radial groove 31 and the outer surface of the actuator rod 5. Furthermore, the shaft seal ring 33 is designed to sealingly engage an axially aligned end face 35 of the connecting piece 22.

The connecting piece 22 can be made of a metallic material, in particular stainless steel, or of a high-strength plastic. The guide sleeve 30 is preferably made of POM or PEEK, but can alternatively also be made of a metallic material such as brass or bronze.

The end sleeve 41 is used to guide the fastening adapter 91 and to fix the fastening adapter 91 to the connecting piece 22. For this purpose, the end sleeve 41 is divided into an annular section 43 and a sleeve section 44. The ring section 43 has a radial groove 45 that extends outwards in the radial direction and is bounded in the axial direction by a radially inward-projecting ring collar 46. The radial groove 45 is designed to receive a shaft seal ring 47, which rests in a sealing manner in the radial direction in the groove base 48 of the radial groove 45 and on the outer surface of the actuator rod 5. Furthermore, the shaft seal ring 47 is designed to rest in a sealing manner on an axially aligned end face 49 of the end sleeve 41. The sleeve section 44 is formed adjacent to the ring section 43 in the axial direction, which is provided on the inner surface with the internal thread 42 and which has an outer surface 50 profiled in a purely exemplary circular manner, which is formed for a contact on the similarly circularly profiled inner surface 94 of the fastening adapter 91. By way of example, an external diameter of the sleeve portion 44 and an internal diameter of the fastening adapter 91 are adapted to one another such that a transition fit (for example H7/k6 according to DIN 7257) can be ensured, in which the fastening adapter 91 can be manually pushed by a user onto the sleeve portion 42 and is substantially free of play.

In order to ensure a seal between the components of the first end assembly 14 and the outer tube 11, a first ring seal 61 is arranged in a first annular gap 63, which is formed between the end sleeve 41 and the fastening adapter 91. Furthermore, a second annular seal 62 is arranged in a second annular gap 64, which is formed between the fastening adapter 91 and the outer tube.

During the assembly of the end sleeve 41 to the connecting piece 22, the first ring seal 61 is clamped between an end face 51 of the end sleeve 41 and a first end face 95 of the fastening adapter 91, which is arranged opposite. The second ring seal 62 is clamped between a second end face 96 of the fastening adapter 91 and an end face 19 of the outer tube 11 when the end sleeve 41 is mounted on the connecting piece 22.

In order to enable the end sleeve 41 to be screwed onto the connecting piece 22, the end sleeve 41 is provided with key surfaces 52 arranged in pairs and visible in FIG. 1. In order to ensure a favorable sealing effect for the two ring seals 61, 62, it can be provided that the screwing-on process for the end sleeve 41 onto the connecting piece 22 is carried out with a limited torque, with which a pressing out of the ring seals 61, 62 from the respective ring gaps 63, 64 can be avoided.

In the second end assembly 15 according to the representation of FIG. 3, the connecting piece 72 has a simpler design than the connecting piece 22 of the first end assembly 14. In line with the connecting piece 22, the connecting piece 72 also has a coupling section 74 for connection to the inner tube 16. The coupling section 74 is followed by a carrier section 75, the outer surface 76 of which is designed to rest both against the inner surface 18 of the outer tube 11 and against the inner surface 94 of the fastening adapter 91. The connecting section 77 is attached with an external thread 78 to the end sleeve 81, which is fixed to the connecting section 77 by means of an internal thread 82. The first ring seal 61 is accommodated in the first annular gap 63, which extends between an end face 89 of the end sleeve 81 and the first end face 95 of the fastening adapter 91. The second ring seal 62 is accommodated in the second annular gap 64, which extends between the second end face 96 of the fastening adapter 91 and the oppositely arranged end face 19 of the outer tube 11.

As can be seen from the representation in FIG. 1, the end sleeve 81 comprises a mounting flange 90 which is designed to secure the electric motor 3 and which, purely by way of example, is provided with four axial bores (not shown), which are designed to receive mounting screws 10 for securing the electric motor 3 to the end sleeve 81.

As an alternative to the fastening adapter 91 shown in FIGS. 1 to 4, the linear actuator 1 can also be equipped with other freely selectable fastening adapters as are shown in FIGS. 4 and 6 by way of example. The fastening adapter 92 according to FIG. 4 is ring-shaped and has a larger outer diameter than the outer tube 11, so that when the fastening adapter 92 is mounted, axially aligned end faces 97 and 98 adapter 92 project in the radial direction beyond the outer tube 11 and thus enable the use of screw fastenings which pass through the holes 99 formed in the end faces 97, 98 in the axial direction.

The annular fastening adapter 93 has pivot pins 100, which are aligned transversely with respect to the axis of movement 4 and are designed purely exemplarily as circular-cylindrical and which, when accommodated in bearing bushes (not shown), allow a pivotally movable mounting of the linear actuator 1.

1. A linear bearing for a linear actuator, having an outer tube extending along an axis of movement and having an end assembly, the end assembly being arranged on an end region of the outer tube and comprising an end sleeve, a connecting piece, a fastening adapter, a first annular seal and a second annular seal, the connecting piece having a coupling section for fixed coupling of the connecting piece to the outer tube or to an inner tube arranged in the outer tube, and which is adjoined by a carrier section, which carrier section rests against an inner surface of the outer tube and/or of an inner surface of the fastening adapter, the carrier section is located adjacent to a connecting section, the end sleeve being received in the connecting section, the first annular seal being received in a first annular gap between the end sleeve and the fastening adapter and the second annular seal being accommodated in a second annular gap between the fastening adapter and the outer tube, and further having an actuator rod being mounted in the outer tube so as to be linearly movable along the axis of movement and protruding through the end assembly.

2. The linear bearing according to claim 1, wherein the first annular gap is bounded by an axial end face of the connecting piece and by a first axial end face of the fastening adapter and/or wherein the second annular gap is bounded by a second axial end face of the fastening adapter and by an axial end face of the outer tube, the first annular seal and the second annular seal each being produced from a plastic material.

3. The linear bearing according to claim 1, wherein a guide sleeve is arranged on an inner surface of the connecting piece for a sliding guide of the actuator rod.

4. The linear bearing according to claim 1, wherein the connecting section of the connecting piece is provided with an external thread and wherein the end sleeve has a tubular fastening section which engages with an internal thread in the external thread of the connecting piece, and which bears with an external surface against the internal surface of the fastening adapter.

5. The linear bearing according to claim 1, wherein a peripheral radial groove is formed on an inner surface of the connecting piece, a shaft seal ring being held in said groove for a sealing contact with the connecting piece and with an outer surface of the actuator rod.

6. The linear bearing according to claim 1, wherein the fastening adapter is selected from the group consisting of: a mounting ring having axially aligned threaded holes, a fastening ring with pivot bearing journals arranged on both sides and aligned radially, a fastening ring with feet.

7. The linear bearing according to claim 1, wherein a peripheral radial groove is formed on an inner surface of the end sleeve, a shaft seal ring being held in said groove and rests in a sealing manner against the end sleeve and against an outer surface of the actuator rod.

8. The linear bearing according to claim 1, wherein adjacent outer surfaces of the outer tube, of the fastening adapter, of the first annular seal, of the second annular seal and of the end sleeve each have an identical profiling in a projection plane aligned transversely with respect to the axis of movement.

9. The linear bearing according to claim 1, wherein the outer tube is provided with an end assembly in each of the mutually opposite end regions.

10. The linear bearing according to claim 9, wherein the end sleeve of at least one of the two end assemblies has a fastening flange or is coupled with a fastening flange, the fastening flange being designed for the securing of a drive motor.
